(19) United States
(12) Patent Application Publication
(10) Pub. No.: US 2016/0098733 A1
(43) Pub. Date: Apr. 7, 2016

(54) WEB PRESENCE RECOMMENDATION

(71) Applicant: CONDUCTOR, INC., NEW YORK, NY (US)

(72) Inventors: RAJAN ARORA, VENICE, CA (US); BARUCH TOLEDANO, GLEN ROCK, NJ (US)

(21) Appl. No.: 14/877,443

(22) Filed: Oct. 7, 2015

Related U.S. Application Data
(60) Provisional application No. 62/061,114, filed on Oct. 7, 2014.

(51) Int. Cl. G06Q 30/02; H04L 29/08; G06Q 10/08; G06F 17/30

(52) U.S. Cl. CPC G06Q 30/0201; G06F 17/30864; H04L 67/22; H04L 67/02; G06Q 10/087

(57) ABSTRACT

Technologies are generally described for systems, devices and methods effective to generate a report. A keyword related to a product may be received. A network may be monitored for use of the keyword. Keyword data may be produced based on the use of the keyword on the network. Inventory information related to the product may be received from a memory. The keyword data and the inventory information may be transformed into a report. The report may reflect an association between the product and the use of the keyword on the network.

### CROSS REFERENCE TO RELATED APPLICATION

This application claims priority under 35 U.S.C. §119(e) to provisional application U.S. 62/061,114 filed on Oct. 7, 2014, the entirety of which is hereby incorporated by reference.

### BACKGROUND

In a search engine, a crawler aggregates pages from the Internet and ensures that these pages are searchable. The pages retrieved by the crawler are indexed by an indexer. For example, each web page may be broken down into words and respective locations of each word on the page. The pages are then indexed by the words and their respective locations. A user may send a search query to a dispatcher. The dispatcher may forward the query to search nodes. The search nodes search respective parts of the index and return search results along with a document identifier. The dispatcher merges the received results to produce a final result set displayed to a user sorted by ranking scores based on a ranking function. Web page administrators may modify web pages in an attempt to have their page appear higher in a result set for particular queries.

### SUMMARY

In some examples, methods to generate a report are generally described. In some examples, the methods may include receiving, by a processor, a keyword related to a product. In various other examples, the methods may further include monitoring, by the processor, a network for use of the keyword. In some other examples, the methods may further include producing keyword data based on the use of the keyword on the network. In other examples, the methods may further include receiving inventory information related to the product from a memory. In yet other examples, the methods may include transforming the keyword data and the inventory information into the report. In some examples, the report may reflect an association between the availability of the product and the use of the keyword on the network.

In various examples, a computing device is generally described. In various examples, the computing device may include a website query module and a receiving module which may be effective to be in communication with the website query module. In various other examples, the computing device may further include an analysis module which may be effective to be in communication with the receiving module. In still other examples, the computing device may further include a report module which may be effective to be in communication with the analysis module. In some other examples, the computing device may include a memory which may be effective to be in communication with the report module. In some examples, the website query module may be effective to receive a keyword related to a product and store the keyword in the memory. In various other examples, the website query module may be further effective to monitor a network for use of the keyword. In some examples, the receiving module may be effective to receive keyword data based on the use of the keyword on the network. In various other examples, the receiving module may be further effective to receive inventory information related to the product. In some further examples, the receiving module may be effective to store the keyword data and the inventory information in the memory. In some examples, the analysis module may be effective to analyze the keyword data and the inventory information to produce analysis data. In some other examples, the report module may be effective to transform the analysis data to produce a report. In various examples, the report may include instructions to modify a web page related to the product.

In other examples, a computing device is generally described. In some examples, the computing device may include a processor and a memory effective to be in communication with the processor. In some examples, the memory may be effective to store inventory information related to a product. In various examples, the processor may be effective to provide a first keyword to an optimization module. In some examples, the first keyword may be related to the product. In various further examples, the processor may be further effective to provide the inventory information to the optimization module. In some other examples, the processor may be further effective to receive a search engine optimization report from the optimization module. In still other examples, the processor may be further effective to provide a second keyword to the optimization module based on the search engine optimization report. In various examples, the second keyword may be different from the first keyword. In other examples, the second keyword may be related to the product.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

The foregoing and other features of this disclosure will become more fully apparent from the following description and appended claims taken in conjunction with the accompanying drawings. Understanding that these drawings depict only some embodiments in accordance with the disclosure and are therefore not to be considered limiting of its scope, the disclosure will be described with additional specificity and detail by reference to the accompanying drawings in which:

FIG. 1 is a system drawing of a system which may be effective to implement a web presence monitor;

FIG. 2 depicts the system of FIG. 1 with additional details related to implementation of a web presence monitor effective to generate a report;

FIG. 3 depicts a flow diagram for example processes to implement a web presence monitor; all arranged according to at least some embodiments described herein.

### DETAILED DESCRIPTION OF THE PREFERRED EMBODIMENT(S)

In the following detailed description, reference is made to the accompanying drawings which form a part thereof. In the drawings, similar symbols typically identify similar components unless context indicates otherwise. The illustrative embodiments described in the detailed description, drawings and claims are not meant to be limiting. Other embodiments may be utilized and other changes may be made without departing from the spirit or scope of the subject matter presented herein. Various aspects of the present disclosure as generally described herein and as illustrated in the accompanying figures can be arranged, substituted, combined, separated and/or designed in a wide variety of different configurations all of which are explicitly contemplated herein.

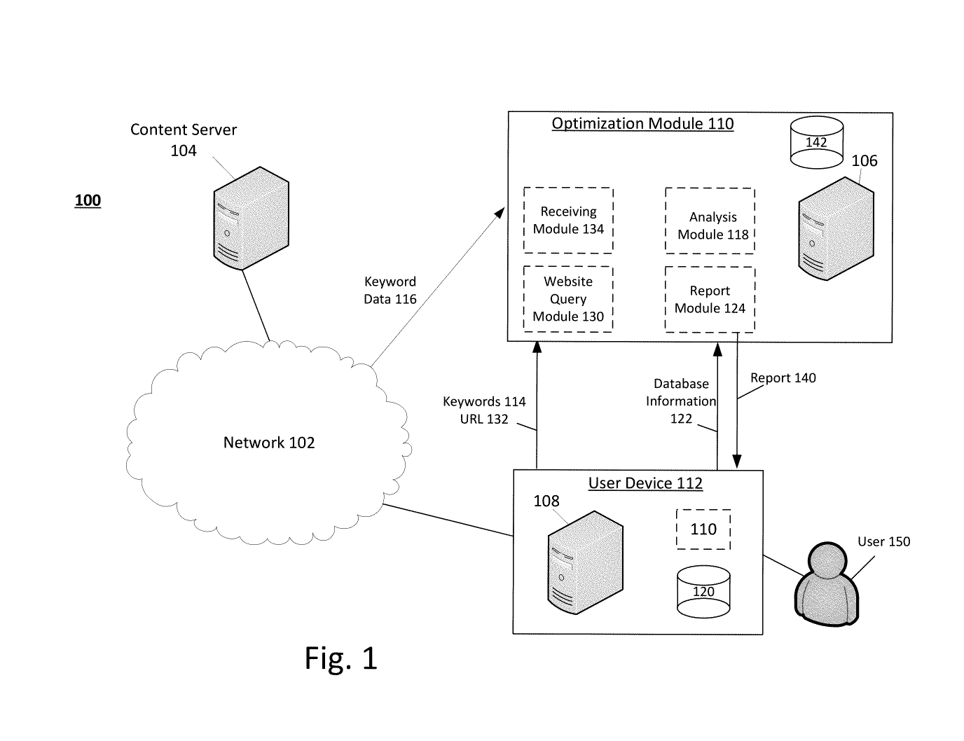

FIG. 1 is a drawing of a system effective to implement a web presence monitor. System 100 may include a user device 112 configured to be in communication with an optimization module 110. In some examples, user device 112 may communicate with optimization module 110 over a network 102. Network 102 may be, for example, the Internet or a local area network. User device 112 may be a user interface and/or computing device which may include a processing unit 108 and a memory 120. As will be described in further detail below, optimization module 110 may include a processing unit 106, a receiving module 134, a website query module 130, an analysis module 118, a report module 124, and a memory 142, all configured to be in communication with one another.

User 150 may be, for example, an individual or an entity. In some examples, user 150 may desire web presence information, search engine rankings, and/or social media posts related to user 150. User 150 may provide one or more keywords 114 to user device 112. Keywords 114 may be, for example, one or more characters, symbols, operators, media files, words, profiles, email addresses, uniform resource locators, and/or other content. In some examples, keywords 114 may be related to products or services provided by user 150, trademarks, slogans, or other terms related to the interests or businesses of user 150. User device 112 may send keywords 114 to processor 106 and/or optimization module 110. In some examples, user device 112 may send at least one uniform resource locators 132 (“URL”), related to user 150, to optimization module 110. For example, user device 112 may send a URL 132 related to a business of user 150 to optimization module 110.

Website query module 130 and/or processor 106 may receive keywords 114 and may monitor network 102 for use of keywords 114. Website query module 130 may store keywords 114 in memory 142. As will be discussed in further detail below, keyword data 116 may reflect use of keywords 114 by users of network 102 as inputs into social media, a search engine, an application interface, and/or a web page, such as, for example, GOOGLE, YOUTUBE, INSTAGRAM, PINTEREST, TWITTER, etc. Optimization module 110 may track and receive usage information regarding keywords 114. Optimization module 110 and/or processor 106 may produce keyword data 116 based on usage of keywords 114 on network 102. For example, receiving module 134 may receive keyword data 116, which may reflect indications of use of keywords 114 on network 102. Receiving module 134 may store keyword data 116 in memory 142. In some examples, keyword data 116 may indicate products of user 150 which have been added to virtual shopping carts by visitors of URLs 132—such virtual shopping cart data may be identified from activities in network 102 and/or from database information 122 retrieved from memory 120. For example, a particular virtual shopping cart for an e-commerce website may include a t-shirt produced by user 150. In the example, keyword data 116 may indicate that the t-shirt has been placed in the particular virtual shopping cart for the particular e-commerce website. In some examples, terms and/or content related to products added to virtual shopping carts may be added to keywords 114 and/or to categories of keywords 114 by processing unit 106 and/or processing unit 108. In some other examples, keyword data 116 may reflect user selections, clicks, or time spent on a particular page related to one or more products of user 150.

Examples of terms and/or content related to products may include general categories of the products, descriptive terms related to the products, image files associated with the products, accessories for the products, terms related to a competitor's products, etc. Tracking terms and/or content related to a particular product through selection of keywords 114 and analysis of keyword data 116 may be used in generation of new content and/or modification of existing content in order to attract or keep audience attention directed toward the particular product. Keyword data 116 may be obtained by processing unit 106 through an application programming interface (API) of a search engine. For example, processing unit 106 may use an API from the GOOGLE search engine in order to identify use of keywords 114. In some other examples, keyword data 116 may be obtained by simulating a web browser and requesting search results related to keywords 114 from content server 104 over network 102. A simulated web browser may issue an HTTP (hypertext transfer protocol) request and receive data related to one or more web pages such as the HTML (hypertext markup language) of the page, JavaScript files and/or CSS (cascading style sheet) files. The HTML, JavaScript, and/or CSS files may be stored in a memory, such as memory 120 and/or memory 142. Keyword data 116 may be obtained from HTML, JavaScript files, CSS files and/or from other content associated with the one or more web pages. For example, the HTML, JavaScript files, and/or CSS files may be searched for keywords 114 to produce keyword data 116. Keyword data 116 may be stored in memory 142.

Analysis module 118 may analyze keyword data 116 and/or database information 122 to provide statistical and analytical data to report module 124. In various examples, analysis module 118 may also provide keyword data 116 to report module 124. For example, analysis module 118 may determine a number of uses of a particular one of keywords 114 over a period of time. In various examples, keyword data 116 may be analyzed to determine a semantic language relationship between keywords 114 and particular online content (which may include products). Examples of relationships between keywords 114 and particular online content may include search volume for the particular content, click-through rates of web pages related to the particular content, rank volatility of web pages related to the particular content, etc. Keyword data 116 may be used to generate an estimate to determine a likely increase in demand for products and/or for content related to products over a period of time. Keywords 114 may be provided as part of a marketing campaign related to a particular topic, such as a particular product line or content of interest. Report module 124 may transform keyword data 116 and/or other data output by analysis module 118 into a report 140 based on the analysis of keyword data 116. In some examples, report 140 may reflect an association between the availability of a particular product and the usage of one or more of keywords 114 on network 102. Report 140 may include a recommendation for user 150 to take one or more actions based on objectives of user 150 and based on analysis of keyword data 116. For example, report 140 may include instructions to modify a web page related to a particular product.

Report module 124, receiving module 134, and/or analysis module 118 may receive database information 122. In some examples, report 140 may be further based on database information 122. Database information 122 may be related to information stored in memory 120 of user device 112 or another memory associated with user 150 and/or optimization module 110. In some examples, database information 122 may include information related to products produced by and/or sold by user 150. For example, database information 122 may include an inventory of products produced by user 150 and/or a record of products purchased through various web pages.

Keyword data 116 may indicate a number of times that particular keywords 114 were used or were present on network 102. For example, keyword data 116 may be a number of times that a particular one of keywords 114 was used as a search query in a search engine over a period of time. In an example where a particular one of keywords 114 is the name of a product, the prevalence of the particular one of keywords 114 may be the number of times the name of the product was used as a search query in network 102 during a particular time period. In some examples, analysis module 118 may analyze database information 122 and keyword data 116. Analysis module 118 may output data to report module 124 which may, in turn, transform data received from analysis module 118 into report 140. Report 140 may be transmitted to user device 112. In some examples, report 140 may recommend that user 150 produce more of the product. Although optimization module 110 is sometimes described and/or depicted as a separate entity or device relative to user device 112, optimization module 110 may be included with, installed on, or otherwise disposed as a part of user device 112. As will be described in further detail below, report 140 may include recommendations and/or computer readable instructions related to implementation of a search engine optimization strategy.

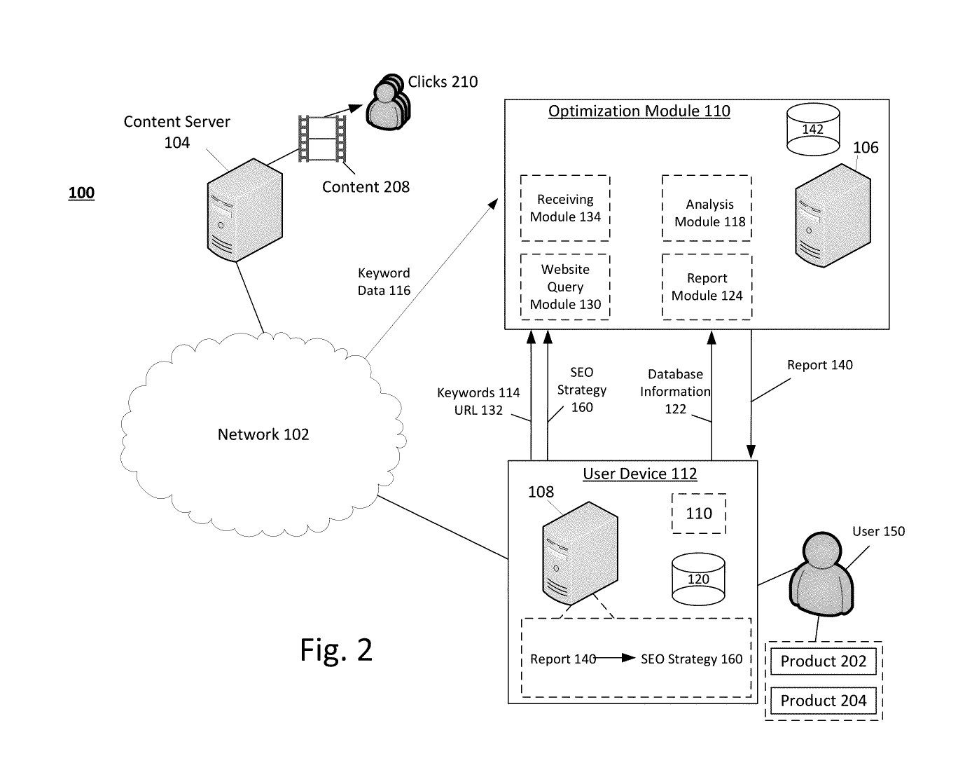

FIG. 2 depicts the system of FIG. 1 with additional details related to implementation of a web presence monitor effective to generate a report. Those components in FIG. 2 which are labeled identically to components in FIG. 1 may not be discussed again for purposes of clarity and brevity.

Report module 124 may generate report 140 which may indicate an increase in Internet traffic related to keywords 114. Keywords 114 may be related to a product 202. Product 202 may be a product produced by user 150 or a business or entity associated with user 150. In an example, the increase in Internet traffic related to product 202 may suggest a low inventory of product 202. Report module 124 may send report 140 to user device 112. User 150 and/or user device 112 may evaluate report 140 to determine whether or not to execute a search engine optimization (“SEO”) strategy 160. In some examples, user device 112 may evaluate keyword data 116 included in report 140. User device 112 may implement SEO strategy 160 which may emphasize product 202 based on the use or frequency of keywords 114 related to product 202 on network 102. In some cases, user device 112 may also use information from database information 122 to implement the particular SEO strategy 160.

In an example, keywords 114 may be ranked according to frequency of usage on network 102. Fluctuation in the ranking of keywords 114 may be used to estimate an increase or decrease in demand for a particular product. In the example, keyword data 116 may indicate an increase in demand across several e-commerce vendors for a particular product. Report 140 may include information related to fluctuation in demand such as an average demand over a period of time, a high benchmark, and/or a low benchmark. SEO strategy 160 may be effective to set growth or decline in demand for the particular product for a particular time period. SEO strategy 160 may be implemented by user device 112, optimization module 110 and/or some combination of user device 112 and optimization module 110. SEO strategy 160 may include various techniques, as described in further detail below, to track data, monitor product information, emphasize new or different products, trademarks, and/or terms related to products on one or more web pages.

In an example, product 202 may be a blue shirt and product 204 may be a red shirt. In the example, report 140 may indicate that users are using keywords 114 in network 102 relating to the blue shirt. Report 140 may further indicate that, according to database information 122, user 150 is low on inventory of blue shirts but has plenty of red shirts. Report 140 may recommend SEO strategy 160. For example, report 140 may recommend SEO strategy 160 based on keyword data 116, analysis of keyword data 116, and/or inventory information from database information 122. Processor 108 of user device 112 may provide content or terms related to red shirts as keywords 114 so that information related to red shirts may be tracked on one or more web pages and/or search engines of network 102. Additionally, in the example above, SEO strategy 160 may recommend that user 150 increase production of blue shirts, based on an estimate of demand for blue shirts. In some examples, an estimate of demand for a product may be based on a frequency of use of keywords 114 which are related to the product.

In some other examples, report 140 may trigger user device 112 and/or optimization module 110 to implement SEO strategy 160. Report 140 may include computer readable instructions which may be effective to implement SEO strategy 160. For example, keyword data 116 may indicate that “Keyword A” related to product 202 was used more frequently than any other of keywords 114 as a search term on a particular search engine or website. Report module 124 may generate report 140 which may include computer readable instructions which may emphasize Keyword A by, for example, embedding Keyword A into metadata or HTML associated with a particular website. In various examples, SEO strategy 160 may reduce optimization of a website found at URL 132 for the keyword “blue shirt” in favor of a keyword that corresponds to red shirts. For example, terminology related to “blue shirt” may be inserted into data or metadata of red shirt web pages such that internet traffic may be steered from blue shirts towards red shirts. In another example, keyword data 116 may indicate that certain terms and/or content associated with red shirts are popular. SEO strategy 160 may associate the more popular terms and/or content with various web pages in order to emphasize the red shirts and/or products related to red shirts. In some examples, terminology and/or content related to “blue shirts” may be removed from web pages to deemphasize blue shirts. In this way, one product may be emphasized over another product. Terms and/or content related to red shirts may be added to keywords 114, so that the terms and/or content may be monitored.

In a further example, web pages related to or associated with blue shirt products may be updated to include red shirt product recommendations for visitors. In various examples, social media tagging may be used to pivot SEO strategy 160 from blue shirts to red shirts. For example, photos of red shirts on social media may be tagged with one or more of keywords 114 related to red shirts. In some other examples, information related to red shirts may be associated with popular click trails in order to emphasize red shirts as part of a modified SEO strategy 160. In various examples, click trails may be the sequence of link selections specific visitors make between entering and leaving a web site. In various other examples, a web page and/or embedded content related to a particular product may be modified based on a frequency of use of a particular one of keywords 114 related to the particular product. In some other examples, a web page and/or embedded content related to a particular product may be modified based on keyword data 116 indicating a particular visibility and/or search engine ranking of the web page.

In another example, a campaign may be created around a type of shoe. Keywords 114 related to the type of shoe may be determined which are most effective for a particular demographic or customer segment. Content on network 102 may be created or modified based on usage of keywords 114. In some examples, efforts to promote the shoe may be concentrated on particular channels that are relevant to the particular demographic or customer segment.

In some examples, keywords 114 may be modified or updated based on, in part, database information 122 and/or keyword data 116. For example, user 150 may desire that a particular product or service provided by user 150 be emphasized in SEO strategy 160. In an example, report 124 may indicate that product 202, identified in keyword data 116, may be expired or may be no longer produced by user 150. User 150 may implement SEO strategy 160 which emphasizes a different product that is similar to the expired product. Information related to the new product may be added to keywords 114 so that network traffic related to the new product may be monitored. Additionally, keyword data 116 may indicate that web site visitors are interested in a product 204. Report 140 may indicate that product 204 is trending among visitors to various web sites. Report 140 may add or may recommend adding terms related to product 204 to keywords 114.

In another example, SEO strategy 160 may be evaluated and/or updated based upon an indication in keyword data 116 of a change in a number of clicks, an amount of time spent by a user on a particular page, and/or an amount of traffic related to a particular product. As a result, processing unit 106 may implement updated SEO strategy 160 which emphasizes the particular product. In another example, report 140 may suggest that user 150 should consider emphasizing the product with new SEO strategy 160. In another example, report 140 may include computer readable instructions which emphasize the particular product. In another example, when a user 150 develops a new product, keywords 114 may be updated to include terms related to the new product. Keywords 114 may be updated by processing unit 106 and/or 108 to include terms related to the new product, so that internet interest in the new product may be monitored. SEO strategy 160 may be updated to emphasize the new product.

Although keywords 114 are described as a searchable feature useful in implementing a web presence monitor as described herein, other data may be tracked and analyzed in order to produce recommendations in report 140. In some other examples, web pages may track and provide data related to registered users of the pages. Views of content 208 provided by user 150 on such web pages may be tracked by, for example, recording a number of clicks 210 associated with the content. In the example, clicks 210 may represent the number of times visitors to a web site selected content 208 while at the web site. In various examples, the content may not necessarily be associated with keywords 114 or other text. In an example, data regarding clicks 210 of content 208, where a purchase is made of a product related to content 208 may be provided to user 150 in report 140. Report 140 may show analytics related to content 208 which may be useful to marketing products of user 150. For example, content 208 may include two different videos which may be shown on various web pages associated with product 204. Analytics may be provided in report 140 related to which video was clicked on more often by purchasers of product 204. As a result, user 150 may produce videos, or other content, which are similar to, or related to, the more popular video.

Among other potential benefits, a system in accordance with the disclosure may provide a marketing professional with guidance as to where to focus search engine optimization efforts based on supply chain information, such as current inventory, expected inventory, production runs, etc. Additionally, a user may be able to adjust inventory and/or production based on use of keywords as search terms on the Internet. A company may adjust search engine optimization strategies based on a current inventory status and/or supply objectives. A system may provide integration between an e-commerce web site and an unearned media channel, such as a paid advertisement or other solicited marketing initiative.

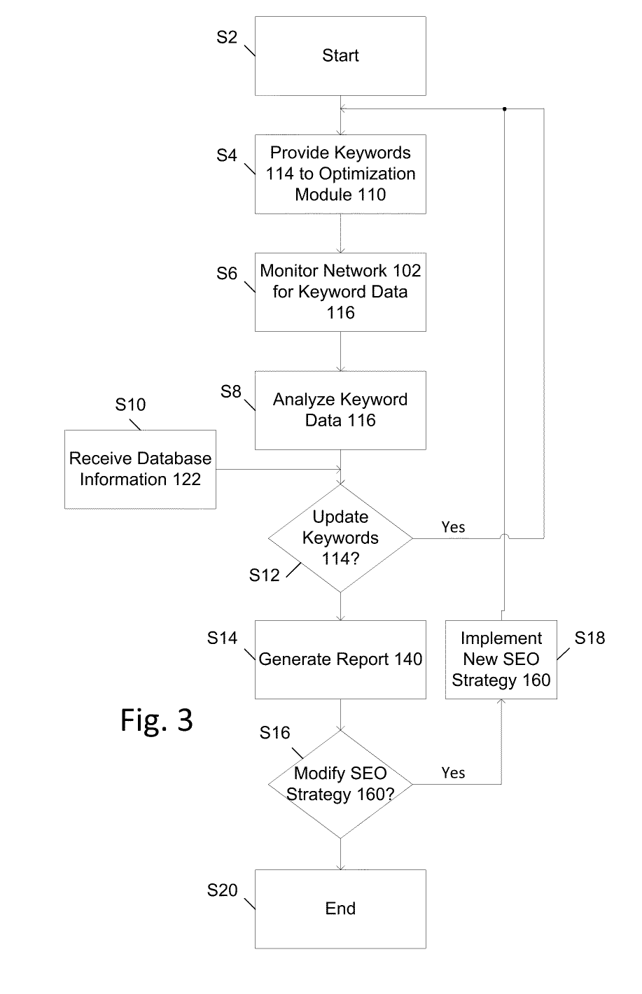

FIG. 3 depicts a flow diagram for example processes to implement a web presence monitor arranged in accordance with at least some embodiments described herein. In some examples, the process illustrated in FIG. 3 could be implemented using optimization module 110 and/or user device 112 described above and could be used to determine whether to recommend changes to an existing search engine optimization strategy or whether to execute a new search engine optimization strategy. In some other examples, the process illustrated in FIG. 3 could be used to adjust inventory and/or production goals. An example process may include one or more operations, actions, or functions as illustrated by one or more of blocks S2, S4, S6, S8, S10, S12, S14, S16, S18, and/or S20. Although illustrated as discrete blocks, various blocks may be divided into additional blocks, combined into fewer blocks, or eliminated, depending on the desired implementation.

Processing may begin at block S2. Processing may proceed from block S2 to block S4, “Provide Keywords 114 to Optimization Module 110.” Keywords 114 may be related to products or services of interest to a particular entity or user of optimization module 110.

Processing may proceed from block S4 to block S6, “Monitor Network 102 for Keyword Data 116.” At block S6, network 102 may be monitored for usage of keywords 114. Keyword data 116 may reflect use of keywords 114 by users of network 102 as inputs into a search engine. Optimization module 110 may receive keyword data 116 from network 102 in response to use of keywords 114 in network 102.

Processing may proceed from block S6 to block S8, “Analyze Keyword Data 116.” At block S8, keyword data 116 may be analyzed. In some examples, analysis of keyword data 116 may indicate associations of keywords 114 with other terms or data. For example, a particular keyword 114 may be associated with a particular image file and/or with a particular product.

Processing may proceed from block S8 to block S10, “Receive Database Information 122.” At block S10, database information 122 may be received by optimization module 110. In some examples, database information 122 may include information related to products produced by and/or sold by user 150 or an entity associated with user 150. In some other examples, database information 122 may include information related to services provided by user 150 or an entity associated with user 150.

Processing may proceed from block S10 to block S12, “Update Keywords 114?” At block S12, a determination may be made as to whether or not to update keywords 114. In some examples, terms included in keyword data 116 which are associated with keywords 114, may be added to keywords 114 and used in monitoring of network 102. In some other examples, various terms included in database information 122 may be added to keywords 114 and used in monitoring of network 102. For example, database information 122 may include the name of a new product. The name of the new product may be added to keywords 114 and used in monitoring network 102.

When a determination is made that no further keywords 114 are to be added to the list of keywords 114, processing may proceed from block S12 to block S14, “Generate Report 140”. At block S14, report module 124 may generate report 140. Report 140 may include a recommendation for user 150 to take one or more actions based on objectives of user 150 and based on analysis of keyword data 116 and/or database information 122.

Processing may proceed from block S14 to block S16, “Modify SEC) Strategy 160?” At block S16, a determination may be made based on report 140 whether or not to modify a particular search engine optimization strategy 160. In some examples, user 150 may determine that a new “Product A” should be emphasized in a search engine optimization strategy based on an inventory of Product A included in database information 122 and based on keyword data 116 indicating an interest in products related to Product A.

When a determination is made that a new search engine optimization strategy 160 should be implemented, processing may proceed from block S16 to block S18, “Implement New SEO Strategy 160”. At block S18, a new search engine optimization strategy 160 may be implemented. For example, an administrator may insert new data or metadata into HTML and/or JavaScript files associated with a web page. The alteration of the web page according to the example may be intended to emphasize the web page in terms of search engine rankings Following the implementation of a new search engine optimization strategy 160, processing may return to block S4. Processing may terminate at block S20. Additionally, the example process depicted in FIG. 2 may be run recursively in order to monitor network 102 for the incidence of keywords 114 over a period of time.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A method to generate a report, the method comprising:
receiving, by a processor, a keyword related to a product;
monitoring, by the processor, a network for use of the keyword;
producing keyword data based on the use of the keyword on the network;
receiving inventory information related to the product from a memory;
transforming the keyword data and the inventory information into the report, wherein the report reflects an association between the availability of the product and the use of the keyword on the network.

2. The method of claim 1, wherein monitoring the network for use of the keyword comprises identifying, through an application programming interface of a search engine, use of the keyword.

3. The method of claim 1, wherein producing the keyword data further comprises:
simulating, by the processor, a web browser; and
requesting over a network, by the web browser, search results related to the keyword from a computing device.

4. The method of claim 3, further comprising:
receiving, from the computing device, at least one of hypertext markup language, JavaScript files, and cascading style sheet files, of a webpage; and
searching the hypertext markup language, JavaScript files, and/or cascading style sheet files for the keyword.

5. The method of claim 1, wherein monitoring the network for the use of the keyword includes identifying a number of times that the keyword has been used as a search term in a search engine during a period of time.

6. The method of claim 1, wherein transforming the keyword data and the inventory information into the report includes:
generating, by the processor, computer readable instructions, wherein the computer readable instructions, when executed, are effective to emphasize the product according to a search engine optimization strategy.

7. The method of claim 1, wherein the report recommends a search engine optimization strategy for the product based on the keyword data and based on the inventory information.

8. The method of claim 7, wherein:
the product is a first product;
the inventory information includes an inventory of the first product and a second product, wherein the second product is different from the first product; and
the search engine optimization strategy emphasizes the second product based on the inventory.

9. The method of claim 8, further comprising implementing the search engine optimization strategy by associating terms or content related to the second product with a web page.

10. The method of claim 8, wherein the keyword is a first keyword, the method further comprising:
adding a second keyword, wherein the second keyword includes at least one term and/or content related to the second product.

11. A computing device, including:
a website query module;
a receiving module effective to be in communication with the website query module;
an analysis module effective to be in communication with the receiving module;
a report module effective to be in communication with the analysis module; and
a memory effective to be in communication with the report module;
the website query module effective to:
receive a keyword related to a product;
store the keyword in the memory; and
monitor a network for use of the keyword;
the receiving module effective to:
receive keyword data based on the use of the keyword on the network;
receive inventory information related to the product; and
store the keyword data and the inventory information in the memory;
the analysis module effective to analyze the keyword data and the inventory information to produce analysis data;
the report module effective to:
transform the analysis data to produce a report, wherein the report includes instructions to modify a web page related to the product.

12. The computing device of claim 11, wherein to monitor the network for use of the keyword, the website query module is effective to:
identify, through an application programming interface of a search engine, use of the keyword.

13. The computing device of claim 11, wherein to monitor the network for use of the keyword, the website query module is effective to:
simulate a web browser; and
request over a network, through the web browser, search results related to the keyword from a computing device.

14. The computing device of claim 13, wherein the receiving module is further effective to:
receive, from the computing device, at least one of hypertext markup language files, JavaScript files, and cascading style sheet files, of a webpage; and
store the files in the memory; and
wherein the analysis module is further effective to:
search the hypertext markup language files, JavaScript files, and/or cascading style sheet files for occurrences of the keyword.

15. The computing device of claim 11, wherein to monitor the network for the use of the keyword, the website query module is effective to identify a number of times that the keyword has been used as a search term in a search engine during a period of time.

16. The computing device of claim 11, wherein:
the inventory information relates to an inventory of the product; and
the report is based on the keyword data and the inventory information.

17. A computing device, including:
a processor; and
a memory effective to be in communication with the processor, wherein the memory is effective to store inventory information related to a product;
the processor effective to:
provide a first keyword to an optimization module, wherein the first keyword is related to the product;
provide the inventory information to the optimization module;
receive a search engine optimization report from the optimization module; and
provide a second keyword to the optimization module based on the search engine optimization report, wherein the second keyword is different from the first keyword, and wherein the second keyword is related to the product.

18. The computing device of claim 17, wherein the processor is further effective to implement a new search engine optimization strategy, wherein the implementation of the new search engine optimization strategy is triggered by the search engine optimization report.

19. The computing device of claim 18, wherein:
the product is a first product; and
to implement the new search engine optimization strategy, the processor is effective to update a web page associated with a second product different from the first product in order to emphasize the second product over the first product.

20. The computing device of claim 17, wherein the processor is further effective to:
evaluate the search engine optimization report, wherein to evaluate the search engine optimization report the processor is effective to determine a number of clicks related to the product, or a time spent on a web page associated with the product.
